(19) United States
(12) Patent Application Publication
(10) Pub. No.: US 2008/0311261 A1
(43) Pub. Date: Dec. 18, 2008

(54) MULTILAYER FOOD PRODUCT PACKAGING MATERIALS, HAVING IMPROVED SEALING AND STIFFNESS

(75) Inventor: George T. GULLICK, Neenah, WI (US)

Correspondence Address: BANNER & WITCOFF, LTD., 1100 13th STREET, N.W., SUITE 1200, WASHINGTON, DC, 20005-4051, US

(73) Assignee: ALCAN PACKAGING FLEXIBLE FRANCE, PARIS CEDEX 16 (FR)

(21) Appl. No.: 12/138,833

(22) Filed: Jun. 13, 2008

Related U.S. Application Data
(60) Provisional application No. 60/943,820, filed on Jun. 13, 2007.

(51) Int. Cl. B65D 85/76; B32B 27/00; B32B 27/18

(52) U.S. Cl. 426/411; 428/519; 428/462

(57) ABSTRACT

Packaging materials comprising a sealant film having at least a skin layer comprising LDPE, a core layer comprising LDPE, MDPE, HDPE, or a blend of any two or all three of these, and a sealant layer comprising EVA copolymer are disclosed. At least one of the layers additionally comprises a stiffening agent such as calcium carbonate. The packaging material is especially useful in applications where good pouch formation and sealing characteristics are needed, such as in the packaging of process cheese products (e.g., loaf).

### CROSS-REFERENCE TO RELATED APPLICATIONS

This application is a non-provisional of U.S. provisional application Ser. No. 60/943,820, filed Jun. 13, 2007, which is hereby incorporated by reference in its entirety.

### FIELD OF THE INVENTION

The present invention relates to a packaging material comprising a sealant film having at least a skin layer comprising LDPE, a core layer comprising LDPE, MDPE, HDPE, or a blend of these, and a sealant layer comprising EVA copolymer. At least one of the layers additionally comprises a stiffening agent such as calcium carbonate. The packaging material is especially useful in applications where good pouch formation and sealing characteristics are needed, such as in the packaging of process cheese products (e.g., loaf).

### BACKGROUND OF THE INVENTION

Wax packaging has been used conventionally for a considerable number of years in food packaging, and especially in the packaging of cheese and processed cheese. For example, cheese manufacturers have utilized wax-coated cellophane or polyester to package 1-, 2-, 3- and 5-pound processed cheese loaves. In addition, machinery has been developed to form wax-coated cellophane film structures for pouches that are then inserted into corrugated boxes and filled with cheese at high temperatures.

These conventional wax products have been successfully applied at pouch filling frequencies or speeds of, for example, 35 pouches per minute or higher for 5 pound process cheese loaf. Wax-based materials also provide the flexibility to form fin seals (in which the same sealant surfaces are mated together along a seal line) or lap seals (in which opposite surfaces of the film overlap to form the seal). Wax pouch structures additionally have stiffness and dead-fold characteristics that enable the formed, empty pouch to stay open and hold its shape as the pouch is transported to filler units over long distances.

Several drawbacks, however, have been encountered in the use of these typical wax-coated cellophane or polyester film structures. First, wax coatings require a starch dusting (such as with potato or corn powder, depending on the final cheese product) to prevent “blocking” (or fusing or sticking together) of the final structure in roll form, due to the softness of the wax. In addition, the starch aids in “cheese release,” enabling the consumer to completely remove the wax coated cellophane structure from the cheese before consumption. Unfortunately, however, these starch coatings tend to rub off of the film during machining, causing an undesirable starch buildup on equipment. Also, the soft wax-based films are temperature sensitive and therefore require special storage conditions. Storage at high temperatures can cause complete blocking of finished film rolls due to activation of the wax coating. Additionally, abnormally cold temperatures cause wax coatings to become brittle, resulting in splitting and/or delamination from the cellophane substrate. Another consideration is the desire for less heat sensitive packaging materials, as cheese manufacturers have increased filling temperatures in newer processed cheese products. Wax typically melts at the same temperature that processed cheese is filled at about 165° F. A reduced heat sensitivity in packaging materials is advantageous for promoting good “cheese release” properties.

In view of these considerations, replacement materials for cellophane and wax coatings would be desirable. Ideally, these materials would have a non-wax sealant film structure which could mitigate or eliminate the drawbacks of the wax-coated cellophane films and still meet the processing and packaging requirements of the food products, and especially cheese products. The higher melting point of polymeric sealant films structures, relative to wax products, could eliminate the need for starch and the associated starch build-up issues.

Polymeric sealant films, including single layer and multilayer structures, are known in the art. For example, U.S. Pat. No. 6,528,134 describes a non-wax film structure comprising three layers, including a sealant layer comprising a polymer or polymer blend and a cheese release agent.

U.S. Pat. No. 5,851,640 describes a multilayer film structure having a core layer, a sealable top layer, and an intermediate layer between the core and sealable layers. U.S. Pat. No. 5,554,245 describes a process for producing a sealable film comprising: (A) producing by co-extrusion through a slot die a cast film comprising a base layer and at least one top layer comprising an antiblocking agent. The film is oriented by biaxial stretching in the longitudinal and transverse directions.

U.S. Pat. No. 5,429,862 describes a sealable film comprising an anti-blocking agent or a lubricant.

U.S. Pat. No. 5,419,934 describes a three-layered film, with two outer layers and an intermediate layer. The intermediate layer and at least one of the two outer layers comprise linear low density poly(ethylene).

U.S. Pat. No. 4,339,498 describes a film comprising a core or substrate layer of propylene and a heat sealable surface layer that is present on either one or both sides of the substrate.

U.S. Pat. Nos. 4,275,120 and 4,291,092 describe multiple layer, heat-sealable films having a substrate layer consisting of a homopolymer or copolymer and at least one heat sealable layer consisting of a homopolymer/copolymer blend.

Typical non-wax, co-extruded films tend to lack the stiffness, dead-fold, pouch forming, and cutting qualities of a typical wax-coated cellophane structure. Thus, these conventional polymeric sealant films are unable to maintain pouch shape at food product filling speeds of greater than 30 or 35 pouches or containers per minute, and under other conditions where it is necessary that the pouch opening remain open during long conveying distances. Pouch formation during filling of the pouch with food product is often problematic due to the “memory” effect of polymers. Additionally, a co-extruded film can be sensitive to the “shear” cutting employed on a typical processed cheese line during pouch formation.

Thus, there remains a need in the art for sealant films which not only have higher melting temperatures than wax-based products, but also have comparable or superior properties in terms of their ability to be cut, stiffness, dead-fold characteristics, sealing, and maintenance of the pouch formation shape (less memory), all of which are important considerations for food packaging.

### SUMMARY OF THE INVENTION

The present invention is associated with the discovery of polymeric sealant films for use in packaging materials that have the necessary structural characteristics to allow for filling of pouches or containers, formed from these materials, with food products such as melted cheese, at commercially desirable manufacturing process conditions. These conditions include transport of open pouches (e.g., on a conveyor belt) over distances exceeding six feet prior to filling of the pouch; food product temperatures, upon filling of the pouch, of higher than about 150° F.; filling speeds of greater than about 35 pouches per minute; and the use of either fin or lap sealing.

Aspects of the invention are related to food packaging materials having the desirable properties, as discussed above, which render them suitable for food packaging and especially for commercial food packaging processes requiring good pouch forming characteristics (e.g., stiffness) and sealing properties. The food packaging materials comprise a sealant film comprising at least three layers, namely (a) a skin layer comprising low density polyethylene (LDPE), (b) a core layer comprising LDPE, medium density polyethylene (MDPE), high density polyethylene (HDPE), or a blend of any two or all of these (e.g., a blend of MDPE and HDPE), and (c) a sealant layer comprising ethylene vinyl acetate (EVA) copolymer. Various other components may also be present in the skin, core, and sealant layers, as would be appreciated by one of ordinary skill in the art. The types and quantities of these components should be compatible with their method of production (e.g., via extrusion) and their use (e.g., the sealant layer should have a melting temperature of greater than about 170° F. for hot food packaging). Haze levels and other factors associated with the appearance of the final packaging material should also be considered.

When used as a blend in the core layer, the relative amounts of LDPE, MDPE, and HDPE can be varied, for example, to adjust the clarity of the sealant film. The MDPE/HDPE ratio in the core layer can therefore be tailored to achieve a desired degree of opaqueness, for example, resembling that of conventional wax-based film. The opaqueness is also a function of the amount and type of stiffening agent used. For example, the use of the stiffening agent calcium carbonate in the skin and core layers in amounts from about 15% to about 25% by weight and from about 35% to about 45% by weight of these layers, respectively, adds a desirable degree of opaqueness to the film for use in cheese packaging materials. Therefore, LDPE, which is clear, can in this case be used exclusively or as a predominant blend component in the core layer (e.g., LDPE in an amount of greater than about 50% by weight in the core layer). This often provides cost advantages relative to the use of blends with greater amounts of MDPE and/or HDPE. Having regard for the present disclosure, one of ordinary skill can readily determine and adjust the parameters which affect the clarity of the sealant film and packaging material, to achieve a desired degree of opaqueness. Other characteristics of conventional wax-coated films, such as the use of starch dusting, may also be employed, although the use of starch is normally avoided.

The EVA copolymer in the sealant layer generally comprises at least about 1% by weight, typically at least about 2% by weight, and often about 3% by weight (e.g., from about 3% to about 15% by weight), vinyl acetate. The sealant layer may also comprise a blend of EVA copolymer and another polymer, such as polyolefin (e.g., polyethylene, polypropylene, or polybutylene).

At least one of the layers (a), (b), and (c), referred to above, comprises a stiffening agent. Thus, for example, the stiffening agent may be in the core layer or it may be in both the core layer and the skin layer. In other embodiments, the stiffening agent is in three or more layers of the sealant film. When a given layer comprises the stiffening agent, it is generally present in an amount representing at least 10% by weight, typically from about 15% to about 95% by weight, and often from about 20% to about 80% by weight, of the layer, in order to provide the sealant film with the desired degree of stiffness. Suitable stiffening agents for a layer include salts such as alkali or alkaline earth metal carbonate, silicate, or sulfate salts. Representative salts which are useful as stiffening agents include calcium salts such as calcium carbonate or calcium sulfate. Other solid particulates and powders, such as clays (e.g., nanoclays) and other minerals, as well as synthetic polymers (e.g., polypropylene) can also be used as stiffening agents. Combinations of these agents may also be employed.

Other aspects of the invention relate to processes for packaging food products, using packaging materials comprising the sealant films described above. Generally, these packaging materials are formed into an open container such as a pouch, wherein an opening at the top of the pouch is sealed after introduction of the food product. Often, it is desired to place or fit a pouch, which is formed from the packaging material, into a more rigid structure such as a cardboard box that constitutes part of the packaged food product.

As discussed above, the packaging materials described herein have properties found to be particularly advantageous in food packaging applications requiring the ability to handle elevated temperatures, high packaging frequencies, and long conveyance or transport distances. Melted processed cheese, for example, upon being introduced into a pouch formed from packaging material, will typically have a temperature of greater than about 145° F., and often in the range from about 150° F. to about 175° F. Packaging speeds are normally greater than about 25 per minute, and often in the range from about 25 to about 40 packages per minute. The packaging materials, by virtue of their comprising a sealant film having a stiffening agent in at least one layer, advantageously maintain their structure, for example, from the time they are inserted into a cardboard box until being filled with food product and ultimately sealed.

The stiffening agent also provides suitable dead-fold (or fold retention) characteristics of the packaging material. Dead-fold refers to a measure of the ability of the packaging material to retain a fold or crease. A simple test for dead-fold property may involve stamping a fold in the packaging material at ambient temperature and then measuring the angle to which the fold opens thereafter. The packaging materials described herein do not significantly straighten (e.g., to not more than about 120 degrees) after being folded.

Representative types of seals used to provide the packaged food product include fin seals and lap seals, as discussed above. Lap sealing, requiring an overlap of opposite surfaces of the packaging material, is often desired, for example, in the packaging of process cheese loaf. Conventional packaging films, however, are generally unsuitable for lap sealing. To improve the ability of packaging materials to form lap seals, it has been determined that the adhesive bonding of an outer layer comprising oriented polypropylene (OPP) to the skin layer of the sealant film, as described herein, is beneficial. Alternatively, the OPP can be extrusion laminated to the skin layer. In addition to OPP, this outer layer may also comprise other components which can aid in providing an effective lap seal, such as saran-coated polyester. Any conventional adhesives, including solvents or solventless adhesives may be used for the adhesive bonding of the outer layer.

These and other aspects and features relating to the present invention are apparent from the following Detailed Description.

### BRIEF DESCRIPTION OF THE DRAWINGS

FIG. 1 depicts a pouch that is formed from packaging material as described herein and inserted into a cardboard box for filling with a food product such as hot processed cheese.

FIG. 2 is depicts a representative 5-layer packaging material as described herein.

### DETAILED DESCRIPTION OF THE INVENTION

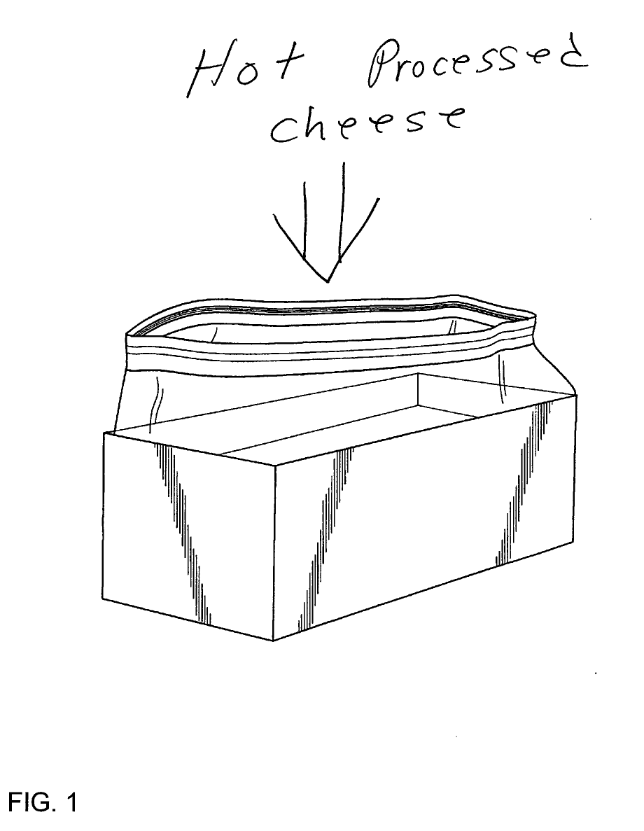

In order for an empty pouch to be suitable for filling with process cheese, the packaging material from which is it formed must maintain a flared, open shape, as shown in FIG. 1. Good shape retention properties, resulting from the use of a stiffening agent in the packaging material, allow the open pouch form to be preserved after the packaging material is inserted into a carton (e.g., a corrugated cardboard box) or tray and also to stay open until it reaches a filling station where a food product such as hot melted cheese is poured into the pouch. The stiffness and dead-fold properties of the material used in forming the pouch must be sufficient to keep the pouch open and allow for conveyor transport over distances generally greater than 6 feet and at line speeds often exceeding 35 filled pouches per minute. As food product cools, it generally takes the form of the pouch inside the carton container. A fin seal or lap seal closure is desirably used for sealing of the pouch, to provide a packaged food product.

To achieve the comparable or superior pouch forming characteristics, in terms of stiffness and sealing properties, as conventional wax-coated materials, an OPP film may be combined with a co-extruded sealant film, as described above, through adhesive lamination. A particular advantage of this combination is that the resulting packaging material has improved lap sealing qualities. A heat sealable OPP film can provide an effective lap seal. It is also possible for the packaging material to utilize a peelable seal.

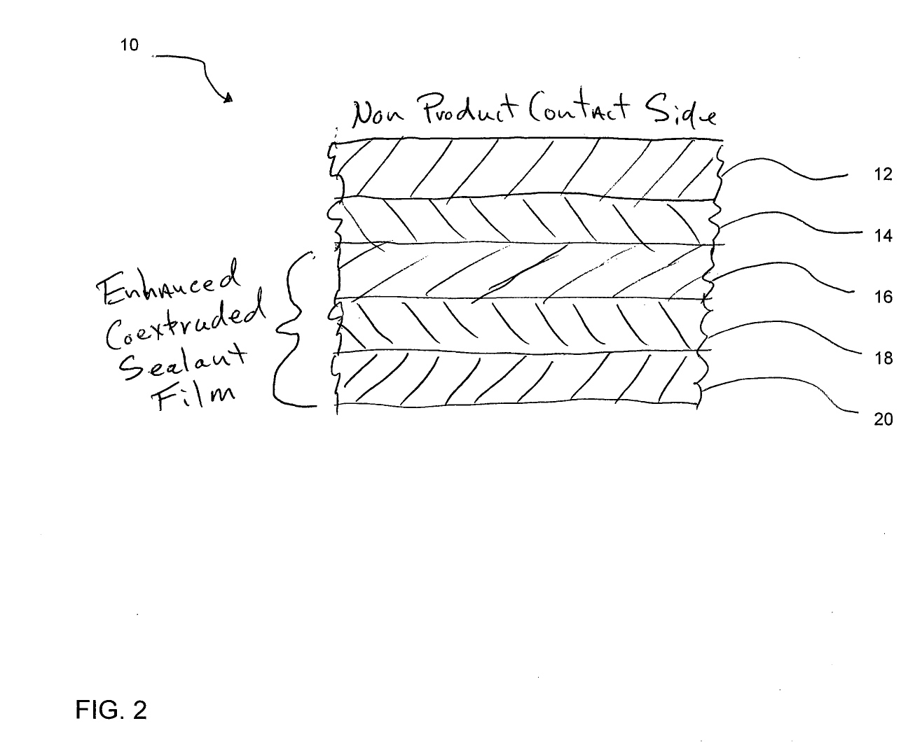

A representative packaging material, as described herein, is shown in FIG. 2. This packaging material 10 is a 5-layer structure comprising a 3-layer sealant film made from layers 16, 18, and 20 which can be co-extruded. These three layers may be blown or cast. A stiffening agent (not shown) such as calcium carbonate is included in one or more of the layers of the sealant film. For example, calcium carbonate may be present in both skin layer 16, comprising LDPE, as well as in core layer 18, comprising both MDPE and HDPE. In other embodiments, the stiffening agent may be included in sealant layer 20, comprising EVA having a vinyl acetate content generally in the amounts given above.

As discussed above, the stiffening agent increases both the rigidity of the packaging material, to provide desired structural integrity during food packaging operations, as well as its dead-fold characteristics. The stiffening agent can also be varied, in terms of the amounts used, and also in terms of the layers into which it is incorporated, to adjust the overall moisture barrier properties as well as the thermal conductivity of the packaging material. A high moisture barrier may be desirable to promote good product appearance, in terms of preventing packaged cheese from drying out and/or cracking. Also, an increase in thermal conductivity, which can result from increasing the quantity of stiffening agent such as calcium carbonate, can advantageously allow the cheese to cool and harder at an increased rate, expediting the manufacturing process.

The representative packaging material 10 depicted in FIG. 2 additionally includes outer layer 12, which is bonded to skin layer 16 through adhesive layer 14. Outer layer 12 comprises OPP which, in addition to the stiffening agent, provides the packaging material 10 with the required stiffness to keep an empty pouch, formed from this material, open for filling with a food product such as hot processed cheese. If a heat-sealable OPP is used, then the OPP itself can improve the ability of the packaging material 10 to form an effective lap seal. Also, the use of a stiffening agent, optionally in combination with the OPP in outer layer 12, improves dead-fold qualities, which also help maintain the structural integrity of a pouch, formed from packaging material 10, so that it advantageously remains in an open position prior to being sealed. Overall, the sealant film comprising layers 16, 18, and 20, optionally in combination with layers 12 and 14, maintains the required stiffness to keep the empty pouch open for filling, after it is inserted into a rigid container, such as a carton or tray, and subsequently transported (e.g., by conveyor) over distances often greater than about 6 feet. The combined packaging material 10 and rigid container are often transported under commercial packaging conditions at manufacturing line speeds of over 35 filled pouches per minute.

Throughout this disclosure, various aspects are presented in a range format. The description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual whole and fractional numbers within that range, for example, 1, 2, 2.6, 3, 4, 5, and 6. This applies regardless of the breadth of the range.

In view of the above, it will be seen that several advantages may be achieved and other advantageous results may be obtained. As various changes could be made in the above compositions and methods without departing from the scope of the present disclosure, it is intended that all matter contained in this application, including all theoretical mechanisms and/or modes of interaction described above, shall be interpreted as illustrative only and not limiting in any way the scope of the appended claims.

The following examples are set forth as representative of the present invention. These examples are not to be construed as limiting the scope of the invention as these and other equivalent embodiments will be apparent in view of the present disclosure and appended claims.

Various experiments were performed in order to investigate the effects of several variables on the characteristics of the resulting packaging materials described herein. For example, the relationships between (a) the amount of added calcium carbonate and packaging material stiffness, (b) the use of calcium carbonate in multiple layers and packaging material stiffness, (c) the amount of vinyl acetate in the sealant layer and the ability to form an effective lap seal (i.e., having good seal strength), and (d) the relative amounts of MDPE and HDPE in the core layer and the clarity of the resulting sealant film, were studied.

Favorable results, in terms of desirable packaging material characteristics, were achieved using at least 20% by weight calcium carbonate in the core layer of the enhanced, extruded film. The use of CaCO₃ in both the core layer and barrier layer provided especially good film properties. A good lap seal was obtained by adhesively laminating OPP to the enhanced co-extruded sealant film comprising at least three layers, as discussed herein. All variations tested had a good dead-fold of less than 120°.

### EXAMPLE 1

Sealant films for packaging materials, as described herein, were prepared with varying amounts of vinyl acetate in the sealant layer, comprising an EVA copolymer. The effect of this variation on lap sealing characteristics was evaluated, and it was determined that increasing levels of vinyl acetate directionally improved the seal. Also, the use of a single site catalyst (SSC) improved the lap seal. In these experiments, CaCO₃ was added to the core layer. The materials used, and their amounts, in each layer of the sealant films are summarized in Table 1.

TABLE 1
Non-wax Sealant Film

| | | % of Layer Weight | | | | |
|---|---|---|---|---|---|---|
| | | Var 1 | Var 2 | Var 3 | Var 4 | Var 5 |
| Layer 1 | Sealant | | | | | |
| | EVA, Exxon Mobil LD- 302.56, | 72.00 | 60.00 | 52.00 | 44.00 | 44.00 |
| | 3.4% VA | | | | | |
| | Polybutylene, Bassell PB8640, | 22.00 | 22.00 | 22.00 | 22.00 | 22.00 |
| | Slip/AB, Ampacet 10516 | 5.00 | 5.00 | 5.00 | 5.50 | 5.00 |
| | Process Aid, Ampacet LP-101919 | 1.00 | 1.00 | 1.00 | 0.50 | 0.50 |
| | LLDPE, DOW 1146G | | | | 28.00 | 28.00 |
| | EVA, ExxonMobil LD-720.01, | | 12.00 | 20.00 | | |
| | 19.3% | | | | | |
| Layer 2 | Core | | | | | |
| | HDPE, L 5885 HD | 75.00 | 75.00 | 75.00 | 75.00 | 55.00 |
| | MDPE, ExxonMobil LD-117.85 | 25.00 | 25.00 | 25.00 | 25.00 | 25.00 |
| | Stiffening Agent (Calcium | | | | | 20.00 |
| | Carbonate), Heritage HM-10 | | | | | |
| Layer 3 | LD Side | | | | | |
| | LDPE, NA 963-083 | 100.00 | 100.00 | 100.00 | 100.00 | 100.00 |

### EXAMPLE 2

Additional sealant films were prepared with the objective of evaluating the amounts of CaCO₃ stiffening agent introduced into various layers. Stiffness and moisture barrier properties were found to be favorable with the use of 40% by weight CaCO₃ in the core layer and 20% by weight CaCO₃ in the skin layer. Overall good sealant film properties were achieved by the use of at least 20% by weight CaCO₃ in two or more layers of the film. Variation of the relative amounts of MDPE and HDPE in the core layer was also evaluated, and it was determined that this variation affected film clarity, but did not have a significant effect on film performance. It was found that the ratio could be manipulated to mimic the look of traditional wax packaging materials. The materials used, and their amounts, in each layer of the sealant films are summarized in Table 2.

TABLE 2
Non-wax Sealant Film

| | | % of Layer Weight | | | | | | | |
|---|---|---|---|---|---|---|---|---|---|
| | | Var 1 | Var 2 | Var 3 | Var 4 | Var 5 | Var 6 | Var 7 | Var 8 |
| Layer 1 | Sealant | | | | | | | | |
| | EVA, Exxon Mobil LD- 302.56, | 44.00 | 44.00 | 44.00 | 44.00 | 44.00 | 44.00 | 72.00 | 72.00 |
| | 3.4% VA | | | | | | | | |
| | Polybutylene, Bassell PB8640, | 22.00 | 22.00 | 22.00 | 22.00 | 22.00 | 22.00 | 22.00 | 22.00 |
| | Slip/AB, Ampacet 10516 | 5.50 | 5.50 | 5.50 | 5.50 | 5.50 | 5.50 | 5.50 | 5.50 |
| | Process Aid, Ampacet LP-101919 | 0.50 | 0.50 | 0.50 | 0.50 | 0.50 | 0.50 | 0.50 | 0.50 |
| | LLDPE, DOW 1146G | 28.00 | 28.00 | 28.00 | 28.00 | 28.00 | 28.00 | | |
| | EVA, Exxonmobil LD-720.01, | | | | | | | | |
| | 19.3% | | | | | | | | |
| Layer 2 | Core | | | | | | | | |
| | L 5885 HD | 55.00 | 45.00 | 45.00 | 45.00 | 45.00 | 35.00 | 35.00 | 35.00 |
| | MDPE, ExxonMobil LD-117.85 | 25.00 | 25.00 | 25.00 | 25.00 | 25.00 | 25.00 | 25.00 | 25.00 |
| | Stiffening Agent (Calcium | 20.00 | 30.00 | 30.00 | | | | | |
| | Carbonate), Heritage HM-10 | | | | | | | | |
| | Stiffening Agent (Calcium | | | | 30.00 | 30.00 | 40.00 | 40.00 | 40.00 |
| | Carbonate), Heritage PolyMax HD | | | | | | | | |
| Layer 3 | LD Side | | | | | | | | |
| | LDPE, NA 963-083 | 100.00 | 100.00 | 80.00 | 80.00 | 100.00 | 100.00 | 100.00 | 80.00 |
| | Stiffening Agent (Calcium | | | 20.00 | 20.00 | | | | 20.00 |
| | Carbonate), Heritage HM-10 | | | | | | | | |

### EXAMPLE 3

Additional sealant films, representing possible films for incorporation into packaging materials used in commercial packaging processes (e.g., food product packaging) described herein, were prepared. The films had the layer compositions, as well as the desired stiffness and sealing properties described herein. The materials used, and their amounts, in each layer of the sealant films are summarized in Table 3.

TABLE 3
Non-wax Sealant Film

| | | % of Layer Weight | | | | |
|---|---|---|---|---|---|---|
| | | Var 1 | Var 2 | Var 3 | Var 4 | Var 5 |
| Layer 1 | Sealant | | | | | |
| | EVA, Exxon Mobil LD- 302.56, | 72.00 | 60.00 | 52.00 | 44.00 | 44.00 |
| | 3.4% VA | | | | | |
| | Polybutylene, Bassell PB8640, | 22.00 | 22.00 | 22.00 | 22.00 | 22.00 |
| | Slip/AB, Ampacet 10516 | 5.00 | 5.00 | 5.00 | 5.50 | 5.50 |
| | Process Aid, Ampacet LP-101919 | 1.00 | 1.00 | 1.00 | 0.50 | 0.50 |
| | LLDPE, DOW 1146G | | | | 28.00 | 28.00 |
| | EVA, ExxonMobil LD-720.01, | | 12.00 | 20.00 | | |
| | 19.3% | | | | | |
| Layer 2 | Core | | | | | |
| | L 5885 HD | 75.00 | 75.00 | 75.00 | 75.00 | 55.00 |
| | MDPE, ExxonMobil LD-117.85 | 25.00 | 25.00 | 25.00 | 25.00 | 25.00 |
| | Stiffening Agent (Calcium | | | | | 20.00 |
| | Carbonate), Heritage HM-10 | | | | | |
| Layer 3 | LD Side | | | | | |
| | LDPE, NA 963-083 | 100.00 | 100.00 | 100.00 | 100.00 | 100.00 |
| | Stiffening Agent (Calcium | | | | | |
| | Carbonate), Heritage HM-10 | | | | | |

### EXAMPLE 4

Additional sealant films, representing possible films for incorporation into packaging materials used in commercial packaging processes (e.g., food product packaging) described herein, were prepared. The films had the layer compositions, as well as the desired stiffness and sealing properties described herein. The materials used, and their amounts, in each layer of the sealant films are summarized in Table 4. The laminate structure composition is summarized in Table 5.

TABLE 4
Sealant Film

| | | % of Layer |
|---|---|---|
| | | Weight |
| Layer 1 | Sealant | |
| | EVA, Exxon Mobil LD- 720.01, 19% VA | 47.50 |
| | Polybutylene, Bassell PB8640, | 15.00 |
| | Slip/AB, Ampacet 10516 | 5.00 |
| | Dow 11146G | 12.50 |
| | Ampacet LP-161608 | 20.00 |
| Layer 2 | Core | |
| | L 5885 HD | 35.00 |
| | LDPE, Equistar NA 963-083 | 20.00 |
| | Heritage HM-10 | 45.00 |
| Layer 3 | LD Side | |
| | NA 963-083 | |
| | Heritage HM-10 | |

TABLE 5
Laminated Structure

75 gauge ExxonMobile 19 MB440
Adhesive, Pechiney Tycel 7668/7276 (100% solids)
2.0 mil sealant film (table 1), electro-statically treated on the LD
side of film

What is claimed is:

1. A food product packaging material comprising a sealant film, said sealant film comprising:
(a) a skin layer comprising low density polyethylene (LDPE),
(b) a core layer comprising LDPE, medium density polyethylene (MDPE), high density polyethylene (HDPE), or a blend of any two or all of LDPE, MDPE, and HDPE, and
(c) a sealant layer comprising ethylene vinyl acetate (EVA) copolymer,
wherein at least one of said layers (a), (b), and (c) comprises a stiffening agent.

2. The packaging material of claim 1, wherein the core layer comprises a blend of MDPE and HDPE.

3. The packaging material of claim 1, wherein said stiffening agent is an alkali or alkaline earth metal carbonate, silicate, or sulfate salt.

4. The packaging material of claim 3, wherein said stiffening agent is calcium carbonate.

5. The packaging material of claim 1, wherein said core layer comprises said stiffening agent.

6. The packaging material of claim 5, wherein either or both of said skin layer and said sealant layer additionally comprise said stiffening agent.

7. The packaging material of claim 1, wherein said stiffening agent is present in at least one of said layers (a), (b), (c) in an amount of at least about 20% by weight.

8. The packaging material of claim 1, wherein said EVA copolymer in said sealant layer comprises at least 3% by weight vinyl acetate.

9. The packaging material of claim 1, wherein said sealant layer comprises a blend of EVA copolymer and a polyolefin.

10. The packaging material of claim 9, wherein the polyolefin is polybutylene.

11. The packaging film of claim 1, further comprising:
(i) an outer layer comprising oriented polypropylene, and
(ii) an adhesive layer that bonds said outer layer to said skin layer of said sealant film.

12. A process for packaging a food product, the process comprising:
(a) inserting a container, formed from the packaging material of claim 1, into a rigid structure,
(b) introducing said food product through an opening in said container, and
(c) sealing said container to provide a packaged food product.

13. The process of claim 12, wherein said food product has a temperature of greater than about 150° F. when introduced into said container in step (a).

14. The process of claim 12, wherein said rigid structure is a cardboard box.

15. The process of claim 12, wherein said container is sealed with a fin seal or a lap seal.

16. The process of claim 15, wherein said open container is sealed with a lap seal.

17. The process of claim 12, wherein steps (a)-(c) are repeated at a rate of greater than about 30 times per minute.

18. The process of claim 12, wherein said food product comprises cheese.

19. The process of claim 12, wherein, subsequent to step (a) and prior to step (b), said food product in said container is transported at least about 6 feet.

20. A sealant film for use in a food product packaging material, said sealant film comprising:
(a) a skin layer comprising low density polyethylene (LDPE),
(b) a core layer comprising low density polyethylene LDPE or an LDPE blend, and
(c) a sealant layer comprising ethylene vinyl acetate (EVA) copolymer,
wherein calcium carbonate is present in said skin layer in an amount from about 15% to about 25% by weight of the skin layer, and wherein calcium carbonate is present in said core layer in an amount of about 35% to about 45% by weight of the core layer.
